(19) United States
(12) Patent Application Publication
(10) Pub. No.: US 2015/0000275 A1
(43) Pub. Date: Jan. 1, 2015

(54) MULTI-STAGE OTEC POWER PLANT

(71) Applicant: Melvin Lewis Prueitt, Los Alamos, NM (US)

(72) Inventor: Melvin Lewis Prueitt, Los Alamos, NM (US)

(21) Appl. No.: 14/272,569

(22) Filed: May 8, 2014

Related U.S. Application Data
(60) Provisional application No. 61/840,613, filed on Jun. 28, 2013.

(51) Int. Cl. F03G 7/05

(52) U.S. Cl. CPC F03G 7/05
USPC 60/641.7

(57) ABSTRACT

A multi-stage power plant. The condenser side of the power plant runs the cold water in series through the stages. The boiler side runs the incoming warm water in parallel among the stages. Furthermore, it has a separate channel for using warm ocean water to drive a super heater for the boiled refrigerant vapor. Means are disclosed for producing large quantities of desalinated water by having the heat transferred from the warm ocean water to the boiler by evaporating and condensing water. Means also are disclosed for producing large quantities of desalinated water by having the heat transferred from the condenser to the cold ocean water by evaporating and condensing water.

### CROSS-REFERENCE TO RELATED APPLICATIONS

This application claims the benefit of the filing of U.S. Provisional Patent Application Ser. No. 61/840,613, filed by this inventor on Jun. 28, 2013, and the specification thereof is incorporated herein by reference.

### BACKGROUND OF THE INVENTION

One of the problems with OTEC (Ocean Thermal Energy Conversion) is that it needs to take cold water from the deep ocean (about 1,000 meters below the surface). In order to boil a refrigerant, such as ammonia or propylene, an OTEC system uses warm surface waters at about 28° C., which is about the average temperature of ocean waters where OTEC plants will be built. Cold water at about 4° C. is drawn up from 1,000 meters down and pumped up to the surface vessel to condense the refrigerant. A conventional 100 MW (megawatt) OTEC plant would require about 200 cubic meters (200 metric tonnes) of cold water per second. That requires a large, expensive pipe and powerful pumps that require vast amounts of power. It also requires millions of pounds of aluminum heat exchangers. OTEC is an old concept that has waited many years to be developed to its full potential, but high capital costs and the excessive energy requirements have hampered progress in the field.

OTEC would offer a nice power source, if a solution could be found to the problem of the huge amount of cold water that needs to be pumped up from the deep ocean. The oceans contain enormous amounts of warm water and cold water. An OTEC plant can run 24 hours per day, unlike the solar plant that shuts down when the sun goes down, or the wind turbine that stops when the wind stops. OTEC does not require energy storage facilities.

### SUMMARY OF THE INVENTION

This document presents a method of efficiently using warm surface ocean water and cold deep ocean water to drive a multi-stage Ocean Thermal Energy Conversion (OTEC) power plant. One of the problems with conventional OTEC power plants is that if a large amount of heat is deposited into the cold water, the engine efficiency decreases. If only a small amount of heat is deposited per cubic meter, the efficiency increases, but the heat capacity of the water is not well used.

The method of this invention is to have several stages of the power plant. Each stage uses a small temperature change for the cold water, but by having several stages, a larger total quantity of the heat capacity can be used. The cold water flows in series between the stages. Another feature of this invention is that the warm water side of the plant flows warm water in parallel with the stages, which tends to improve efficiency. It does require more warm water, but the warm water does not have to be pumped very far. Another feature of this invention is that after the warm water boils the refrigerant in the boiler, the refrigerant vapor flows to a counter-flow heat exchanger where a separate flow of warm ocean water superheats the refrigerant, which increases the efficiency.

Let us consider a three-stage OTEC plant. Cold water from deep ocean enters the first stage at approximately 4° C. and flows through the condenser to condense the working fluid that is coming from the turbine. The water warms up to about 10° C. and then it flows to the second stage where it flows through the condenser and heats up to about 16° C. Then it flows to the third stage condenser and heats up to approximately 22° C. Finally the water is discharged. It can be discharged through a diffuser exhaust port to recover some of the kinetic energy of the water.

When the working fluid (refrigerant) is condensed to liquid in the condensers of each stage, the working fluid is pumped to the boiler of that stage. Warm seawater at temperature of about 28° C. enters each stage boiler, where it boils the working fluid at a temperature of approximately 23° C. That warm seawater flows down through the boiler and then flows out to the seawater discharge pipe. Some of the fresh warm seawater enters counter-flow heat exchangers to superheat the working fluid vapor up to about 27° C. After the warm seawater leaves the bottom of each counter-flow super heater, it flows down to the lower part of the boiler where it pre-heats the liquid working fluid in preparation for boiling the working fluid. Then that water flows out to the seawater discharge pipe.

The boiled working fluid in each stage flows up to the counter-flow super heater, flows through the super heater, and then flows to the turbine of each stage. The turbines turn generators that generate electricity. After leaving the turbines, the working fluid flows to the condensers to be condensed and then repeats the cycle.

How much cold water is needed to drive this system? The power is

P=H_{w}−H_{c}

where H_{w} is the heat from the warm water, and H_{c} is the heat deposited in the cold water.

Therefore,

H_{c}=H_{w}−P

Also

P=EH_{w}

where E is the efficiency. Therefore,

H_{c}=P(1−E)/E

The power in terms of cold water heat extraction and the efficiency is then

P=H_{c}E/(1−E)

To calculate the Carnot efficiency, we consider each stage and sum the total efficiency. The Carnot efficiency equation is

E=(Tₕ−T_{c})/(273.15+Tₕ)

where the temperatures are listed in degrees Celsius. Tₕ is the hot temperature of the working fluid entering the turbine. T_{c} is the cold temperature of the condensed working fluid in the condenser. Refer to FIG. 1 for the temperatures of a three-stage plant. For the first stage,

E₁=(27−10)/(273.15+27)=0.0566

For the second stage, E₂=(27−16)/(273.15+27)=0.0366. For the third stage, E₃=(27−22)/(273.15+27)=0.0167.

To allow for mechanical and heat exchanger inefficiencies, we can multiply each efficiency by 0.7 and get E₁=0.0396, E₂=0.0256, and E₃=0.0117.

As the cold water flows through the three stages, the temperature changes by 18° C. Since a cubic meter of water contains 1 million grams of water, and since the change in a gram of water by 1° requires one calorie of energy, and a calorie is equivalent to 4.184 joules, changing 1 cubic meter of water by 18 degrees requires 75,312,000 joules.

P₁=25,104,000 E₁/(1.−E₁)=1,035,109

Similarly, P₂=695,547, and P₃=297,194. The total power from the three stages would be 2,027,850 per cubic meter of cold water. If we divide that into 100 MW, we get 49.31 cubic meters of cold water per second, which is the amount of cold water per second that is needed for a 100 MW OTEC plant.

That is a dramatic reduction from the 200 cubic meters per second of the conventional OTEC plant.

The table below shows the requirement for cold water and warm water for our three-stage OTEC plant. The first two data columns of the table below are from a patent application “Industrial Ocean Thermal Energy Conversion Processes,” with first-named inventor Laurence J. Shapiro. (U.S. Patent App. Publication No. 2012/00723291, application Ser. No. 13/183,047).

The last column in Table I is for the three-stage OTEC plant design of this invention. It is illustrated by Three-Stage diagram as shown FIG. 1.

TABLE I
This table is for a 100 MW OTEC three-stage plant

| | Conventional | Four Stage | Prueitt Three |
|---|---|---|---|
| | OTEC (m³/s) | Hybrid (m³/s) | Stage (m³/s) |
| Cold Seawater | 222.0 | 143.6 | 49.31 |
| Flow | | | |
| Warm Seawater | 302.4 | 239.2 | 148 |
| Flow | | | |

The warm water enters the stages in a parallel manner. The cold water enters the stages in series.

People who are well-familiar with OTEC technology and who are accustomed to seeing numbers like 200 metric tonnes per second for the cold water flow in a huge pipe from 1,000 meters down in the ocean will appreciate the possibility of having a 100 MW OTEC plant requiring only 49.31 metric tons per second, as shown in Table I. The presently disclosed technology would save a lot of money on the pipe and on pumps and on pumping power. It would also save a lot of money on the heat exchangers. A lot of heat exchangers are necessary to process 200 tonnes of water per second.

This invention can also support plants that have more or fewer stages than what is shown in FIG. 1. For example, if an extra stage is added to FIG. 1, there would be four cold stages and four warm stages, and the flow of cold water would be 46.87 cubic meters of cold water per second. If the design is changed to have five cold-water stages, 44.96 cubic meters of cold water would be required per second.

It is therefore an object of the present invention to provide a method of staging OTEC power plants so that a much smaller quantity of cold and warm ocean water is required to provide a sizeable amount of electric power.

It is another object of the present invention is to have the cold water flow in series between the stages.

It is another object of the present invention is to have the warm water flow in parallel among the stages.

It is another object of the present invention is to provide super heating for the boiled working fluid, and the super heating is provided by counter-flow heat exchangers so that the vapor flowing to the turbines is very close to the temperature of the warm ocean surface temperature.

It is another object of the present invention is to provide for a various number of stages for different applications.

It is another object of the present invention is to use the warm ocean exiting from the counter-flow heat exchanger to provide pre-heating to the liquid working fluid as it flows into the boilers.

Other objects, advantages and novel features, and further scope of applicability of the present invention will be set forth in part in the detailed description to follow, taken in conjunction with the accompanying FIG. 1, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate embodiments of the present invention and, together with the description, serve to explain the principles of the invention. The drawings are only for the purpose of illustrating preferred embodiments of the invention and are not to be construed as limiting the invention. In the drawings:

FIG. 1 is a schematic drawing that presents the theory of the operation of the New Multi-Stage OTEC Power Plant. It shows three stages, but it should be understood that there can be other numbers of stages.

FIG. 2 is a schematic drawing that illustrates a method of desalinating water by having heat transferred from the warm ocean water to the boiler by evaporating water and having the water vapor transport the heat to the boiler.

FIG. 3 is a schematic drawing that illustrates a method of desalinating water by having heat transferred from the condenser to the cold ocean water by evaporating water and having the water vapor transport the heat from the condenser to the cold ocean water.

FIG. 4 is a schematic drawing that shows one method of producing a part of a heat exchanger.

### DETAILED DESCRIPTION OF THE INVENTION

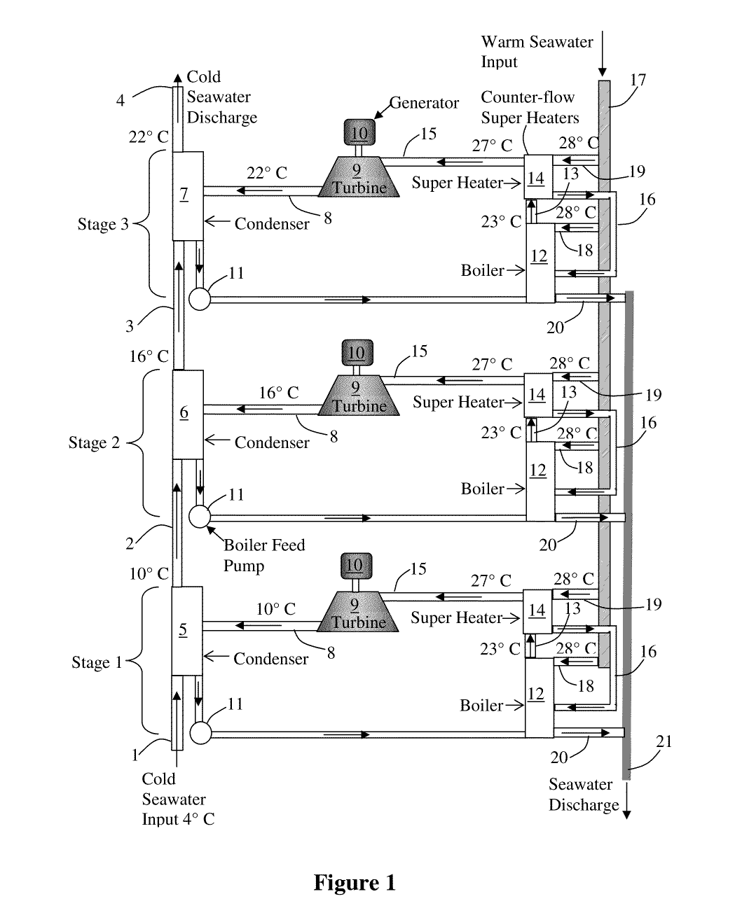

FIG. 1 presents the theory of operation of this invention as a three-stage OTEC Power Plant. It should be understood that there can be more or fewer stages than three. Note that Stage 1, Stage 2, and Stage 3 are identified on the left of the figure, and the brackets (“Stage 1,” Stage 2,” and “Stage 3”) show where the stages are. That is, everything to the right of each bracket is part of the corresponding stage. Pipe 1 is where the cold water is brought into condenser 5. Then after the water is warmed, as it condenses some working fluid in condenser 5, pipe 2 takes the water from condenser 5 to condenser 6. Pipe 3 takes the water from condenser 6 to condenser 7. Pipe 4 takes the water from condenser 7 and discharges the water into the ocean. Pipes 8 take working fluid vapor from turbines 9 to the condensers. Turbines 9 are all given the same number, even though the higher turbines have different operating conditions due to the different temperatures of the condensers. The generators all have the label number 10.

After the working fluid is condensed in the condensers, pumps 11 pump the working fluid to the respective boilers 12. After the working fluid is boiled in the boilers, the working fluid vapor flows through pipes 13 into the counter-flow super heaters 14, where they are heated to about (for example) 27° C. (depending on the temperature of the local ocean surface). Notice that the vapor leaving the boilers has a temperature of (again, by way of typical example) about 23° C. Pipes 15 carry the super heated working fluid to the turbines.

After the warm ocean water flows down through the counter-flow super heaters 14, the water exits the bottom of the super heaters through pipes 16 and flows to the lower part of the boilers 12; it then is used to pre-heat the working fluid before it is boiled. Alternatively, the warm seawater in pipes 16 could be carried to pre-heaters to heat the liquid working fluid before it flows into the boilers.

The warm ocean water flows in through pipe 17. Then it flows into the boilers 12 through pipes 18. Warm water also flows from pipe 17 into the super heaters 14 through pipes 19. The water flows out the bottoms of the boilers 12 through pipes 20 and then flows into the discharge pipe 21.

### Water Desalination

In addition to generating power, this invention provides methods to produce fresh water from seawater. The inventive methodology uses water vapor as a heat transfer medium. It is, in effect, like a heat pipe. Some heat pipes can conduct heat 20,000 times a fast as copper. By having water evaporate from a surface, it removes heat from that surface. Then the water vapor flows to a boiler surface and condenses on that surface. That deposits the heat into the surface.

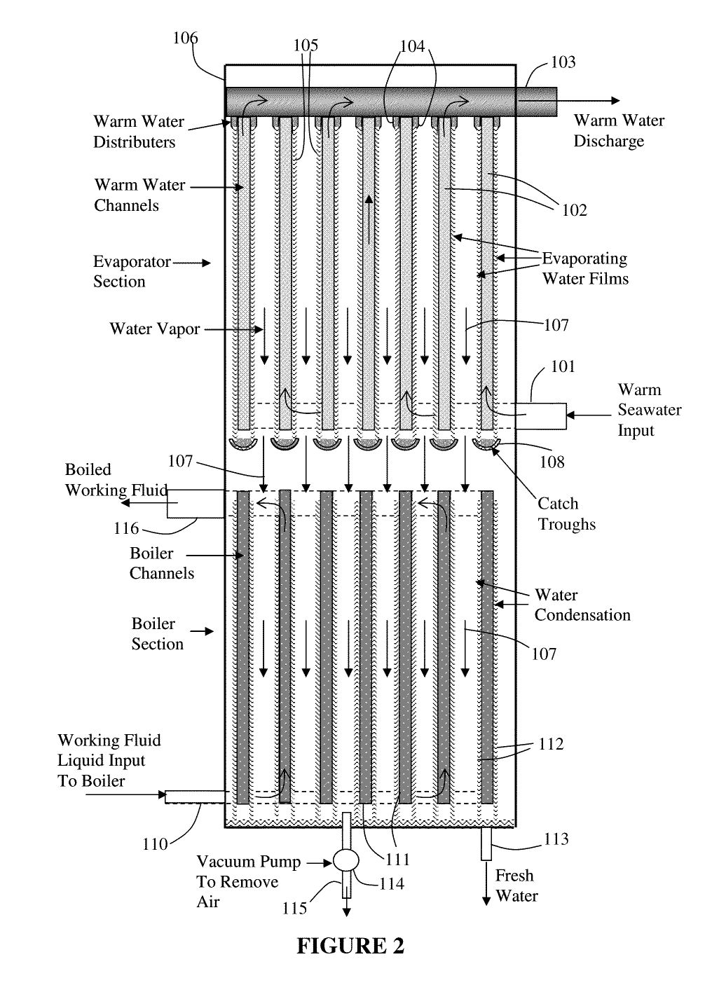

In FIG. 2, warm seawater enters from the right through pipe 101 and has connections to the vertical warm water channels 102. These channels could be tubes or spaces between flat plates. The warm water channels are vertical, and the warm water flows upward in the channels. Part of the warm water exits at the top and flows out the warm water discharge pipe 103. Part of the water flows through water distributers 104 and flows as water films 105 down the outside of the warm water channels 102 in the “vacuum.” The advantage of this design is that the water film can flow down the outside of tubes or down both sides of flat sheets. As the water flows up through the vertical channels 102, it transfers heat out through the walls, and this heat keeps the water film on the outside hot, and that causes the water to evaporate. The water vapor 107 then flows to the boiler channels 111, where it condenses and deposits its heat of condensation. Most of the water flowing up in the channels flows out the discharge tube 103 to the right and is discarded. By having only part of the water flow down as a film 105, less air will escape from the water into the vacuum. When the water film gets to the bottom, it is caught by catch troughs 108 and is discarded to a warm water discharge pipe 103. This warm water discharge can be used to preheat the liquid refrigerant that comes from the condenser on its way to the boiler (see FIG. 1). Similarly, the fresh water that is produced is warm, and it can be used to preheat the liquid refrigerant. These actions can reduce the required amount of warm water.

As the water vapor 107 flows down to the boiler, it flows between and condenses on the boiler channels 111 and deposits heat in the liquid refrigerant. The liquid refrigerant enters through pipe 110 and flows up the boiler channels 111. The refrigerant boils and passes out through pipe 116. From there, it flows to a super heater or flows to the turbine (e.g., as seen in FIG. 1).

Also, as the water vapor 107 flows to the boiler, it carries the dissolved air with it. And as the water vapor flows along the surface of the boiler channels 111, it tends to carry the air with it. When the air gets pushed to the bottom of the chamber 106, there is a vacuum pump 114 to remove the air through pipe 115. It is not necessary to pre-deaerate the water before it flows into the evaporator section. Only about 5% of the water enters the vacuum chamber 106. Most of the air is carried out with the water flowing through the warm water discharge pipe 103. The geometry near the bottom can be designed so that the air is concentrated to a smaller volume, but this is not shown in the figure.

The desalinated water flows out pipe 113. Since it is exiting from a partial vacuum, it must be pumped out, unless the vacuum chamber is sufficiently high so that gravity will remove it.

It is a good idea to have a thin coat of hydrophilic material on the surfaces, so that the water film tends to spread out all across the surfaces.

In FIG. 2, the water vapor can flow directly down from the evaporator into the boiler, where it condenses on the surface of the boiler and discharges its condensation energy into the boiler. The condensed water flows down and is collected as fresh water.

We can have a single unit like FIG. 2 that can feed warm water vapor to all the boilers in the separate stages. Or, we can have separate units like FIG. 2 for each stage.

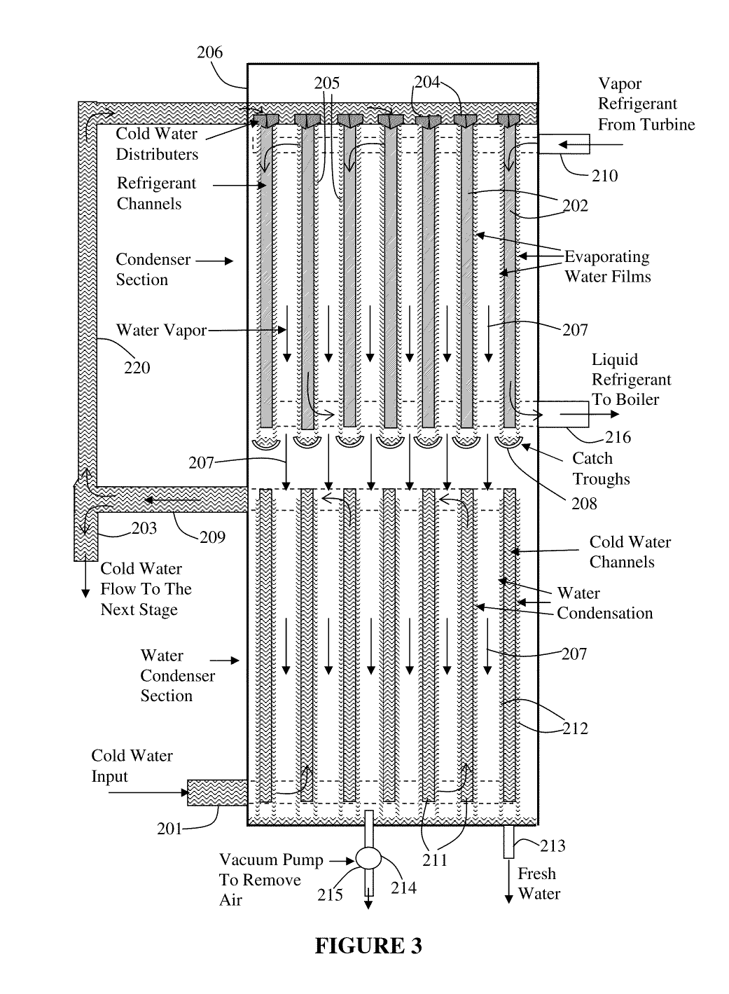

We can not only produce fresh water from seawater on the boiler side of the OTEC plant, as shown in FIG. 2, but we can also produce fresh water from seawater on the cold water side of the OTEC plant. Its design is shown in FIG. 3. If it is desirable to produce fresh water on both the boiler side and the condenser sit, it would be necessary to have a separate system like FIG. 3 for each condenser stage of the plant.

For this design, a similar system is used to condense the refrigerant vapor that exhausts from the turbines. That refrigerant condenser is placed above the cooler (water condenser section) within the vacuum chamber 206. The refrigerant vapor enters the condenser section through pipe 210 and flows down the inside of the condenser channels 202. There is a source of cold water entering through pipe 201. The water flows up through channels 211 and out through pipe 209. Part of the water flows out pipe 203, which can supply cold water to the next stage or can discharge the cold water. The rest of the water flows up through pipe 220 and then flows through water distributors 204, that supplies films 205 of cold water running down the outside of the condenser channels 202. As the refrigerant vapor condenses inside the channels, it releases heat. That heat is absorbed by the water film 205 running down the outside and produces water vapor 207. The water vapor flows down to the water condenser section, where it condenses on the outsides of cold water channels 211 that contain flowing cold water from deep sea. The condensed water (films 212) runs down and is collected as fresh water through pipe 213.

The water caught in the catch troughs 208 and the fresh water is cold, so it can be directed to the next stage to provide cooling. That will increase the efficiency.

Again there will be air in the water vapor. It is swept downward with the flow of the vapor and the downward water flow of the water film on the cold water channels. A vacuum pump 214 removes the air and pumps it out pipe 215.

To calculate how much water is desalinated on the cold water side, we can use the equation H_{c}=P(1−E)/E, but it is simpler just to use the temperature change through the stages. I have written a computer program called otecnew.exe that calculates the efficiency and power. For the three-stage model, rather than use a 6 degree temperature change, I used a 5.7 degree change. Looking at FIG. 3, we can see that the heat is transferred by water vapor. For each cubic meter of water that flows through, the amount of heat flow is 5.7 calories per gram for one million grams or 5.7 million calories. At those temperatures, the latent heat of vaporization (and condensation) is about 585 calories per gram so that 9,744 grams are evaporated (and condensed) per second. That is 2.578 gallons per second per cubic meter of water. We multiply that by the number of cubic meters per second (49.31) and get 127.1 gallons per second. That is 10,981,860 gallons per day for one stage. For the three stages, it is 32.94 million gallons per day for the 100 MW plant. These calculations were done for the situation in which we multiplied the efficiencies by 0.7 to allow for mechanical and heat exchanger losses.

For the warm water side, H_{w}=P/E. It should be remembered that the principle concern regards the amount of cold water that must be pumped up from 1,000 meters down. For the first stage, P=1,002,670 watts per cubic meter of cold water per second. The efficiency (X 0.7) is 0.0403. Thus H_{w1}=24,880,149 watts. We divide that by 4.184 to get the number of calories per second. At the warm water side, the heat of vaporization (or condensation) is about 580 calories per gram. That gives 10,253 grams or 2.71 gallons per second (per cubic meter of cold water per second). Then we multiply by 49.31 to obtain the 100 MW power level; 133.74 gallons per second or 11.555 million gallons per day are realized. If the same process is performed for stages 2 and 3, then there are obtained about 34.12 million gallons of fresh water per day from the warm side. Adding that to the 32.94 million gallons from the cold water side, the total is 67.06 million gallons per day for the 100 MW plant. The superheat energy is not used for desalination.

If a question remains why the warm water side is multiplied by 49.31 (the amount of cold water per second), it is because the power P is given by P=H_{c}E/(1−E), and H_{c} is the amount of heat delivered to the cold water when P is equal to 100 MW.

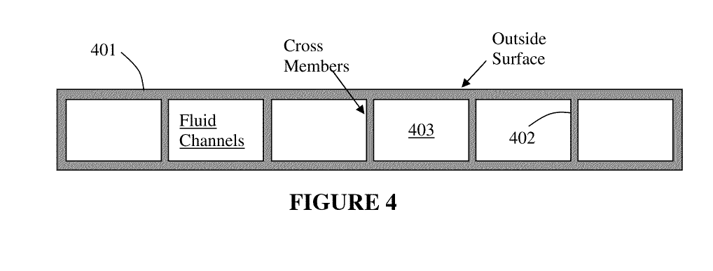

To provide added strength to the warm water channels and the boiler channels, these channels may be constructed of extruded aluminum, as shown in an end view in FIG. 4. The outside surface 401 provides surfaces down which the water film can flow. The cross members 402 provide strength to sustain the pressure within, and they provide extra heat channels to transfer heat between the outside surface and the fluid within. The channels within 403 provide paths in which the fluids may flow.

As in the boiler section, the condenser can consist of tubes or structures like FIG. 4.

Although specific embodiments have been illustrated and described in this disclosure, it will be appreciated by those of ordinary skill in the art that any arrangement that is calculated to achieve the same purpose may be substituted for the specific embodiment shown. This application is intended to cover any adaptations or variations of the present invention.

I claim:

1. An ocean power generation system for efficiently using the temperature differential between the warm surface water and the cold deep water, comprising a first stage comprising:
a heat exchanger boiler, which uses warm water to provide heat for evaporating a refrigerant liquid to produce a refrigerant vapor;
a means for conducting additional warm water to a counter-flow heat exchanger to super heat the refrigerant vapor;
a pipe for conducting the refrigerant vapor from the heat exchanger boiler to the counter-flow heat exchanger;
a pipe for conducting the refrigerant vapor from the counter-flow heat exchanger to a turbine;
a pipe for conducting a warm water exhaust from the counter-flow heat exchanger to an initial part of the boiler to pre-heat the refrigerant liquid;
a condenser for changing the refrigerant vapor to refrigerant liquid;
a conduit for conducting the refrigerant vapor from the turbine to the condenser;
a means for conducting cold water to the condenser to condense the refrigerant vapor to a liquid;
a pipe for conducting the cold water out of the condenser; and
a means for pumping the refrigerant liquid from the condenser back to the heat exchanger boiler to repeat the cycle;
wherein the boiler receives the refrigerant liquid and receives the warm water and transfers heat from the warm water to the refrigerant liquid and boils the refrigerant liquid to become high-pressure refrigerant vapor, and wherein the high-pressure vapor flows through the counter-flow heat exchanger to accept heat from the additional warm water, and wherein the high-pressure vapor flows through the turbine and then flows to the condenser where it is condensed by losing heat to the cold water.

2. The system according to claim 1, further comprising a second stage substantially identical to the first stage, wherein cold water ejected from the first stage is an intake cold water for the second stage, and the boiler and the counter-flow heat exchanger of the second stage do not use warm water ejected from the first stage, but use a fresh warm water.

3. The system according to claim 1, wherein heat is transferred from the warm water by having the warm water flow through a warm water channel, and a film of water flows down the outside of the warm water channel, and the film of water evaporates to form water vapor in a vacuum chamber, and the water vapor flows between boiler channels containing a refrigerant, and the water vapor condenses on the boiler channels, and the condensation of the water vapor on the boiler channels transfers the heat of condensation into the boiler, thus boiling the refrigerant and providing a pressurized refrigerant vapor that flows to a turbine.

4. The system according to claim 1, wherein cold water flows down the outside of a condenser channel, and the cold water evaporates to water vapor in a vacuum, and the evaporation of the cold water cools the refrigerant vapor, thereby condensing the refrigerant vapor to a liquid to be pumped back to the boiler, and the water vapor flows to and between cold water channels containing flowing cold water, and the water vapor condenses on the cold water channels to produce fresh water.

5. The system according to claim 1, wherein each boiler and condenser comprises tubes for the condenser channels.

6. The system according to claim 1, wherein each boiler and condenser comprises extruded aluminum forms flat surfaces on each side of each form and having cross members inside each form that extend from one of said flat surfaces to another of said flat surfaces.

7. The system according to claim 1, further comprising a plurality of additional stages substantially identical to the first stage, wherein cold water ejected from a previous additional stage is an intake cold water for a subsequent additional stage, and wherein the boiler and the counter-flow heat exchanger of the subsequent additional stage do not use warm water ejected from the previous additional stage, but use a fresh warm water.

8. The system according to claim 4, wherein at least a portion of the cold water in the cold water channels flows on to the condenser channel.
